(19) United States
(12) Patent Application Publication
(10) Pub. No.: US 2015/0046249 A1
(43) Pub. Date: Feb. 12, 2015

(54) METHOD AND SYSTEM FOR MEASURING WEB ADVERTISING EFFECT BASED ON MULTIPLE-CONTACT ATTRIBUTION MODEL

(71) Applicants: Guosheng Qi, Beijing (CN); Kaiduo He, Beijing (CN); Jian Huang, Beijing (CN); Wentao Zhang, Beijing (CN); Qing Zhu, Beijing (CN); Yongjian Huang, Beijing (CN)

(72) Inventors: Guosheng Qi, Beijing (CN); Kaiduo He, Beijing (CN); Jian Huang, Beijing (CN); Wentao Zhang, Beijing (CN); Qing Zhu, Beijing (CN); Yongjian Huang, Beijing (CN)

(73) Assignee: BEIJING GRIDSUM TECHNOLOGY CO., LTD., Beijing (CN)

(21) Appl. No.: 14/386,389

(22) PCT Filed: Jul. 25, 2012
(86) PCT No.: PCT/CN2012/000998

§ 371 Date: Sep. 19, 2014

(30) Foreign Application Priority Data
Mar. 19, 2012 (CN) 201210072847.1

(51) Int. Cl. G06Q 30/02; G06F 17/30

(52) U.S. Cl. CPC G06Q 30/0242; G06F 17/30592; G06F 17/30371
USPC 705/14.41

(57) ABSTRACT

The disclosure discloses a method and a system for measuring a web advertising effect based on a multiple-contact attribution model. The method comprises: collecting user access information and purchase transformation information of a website, and uploading the user access information and purchase transformation information to a server side; cleaning data for the user access information and the purchase transformation information on a server side; calculating contact contribution value data and importing the contribution value serving as fundamental metrics and contact information serving as dimensionalities into OLAP database, and aggregating data. The method and the system can help an advertiser to understand actual web advertising effect from a number of perspectives to accurately measure underestimated or overestimated channel value in conventional methods, thereby providing the most accurate data support for optimizing web advertising and improving rate of return on investment.

### TECHNICAL FIELD OF THE DISCLOSURE

The disclosure belongs to the technical field of web, and relates to the evaluation of web marketing and web advertising effects, in particular to a method and a system for measuring a web advertising effect based on a multiple-contact attribution model.

### BACKGROUND OF THE DISCLOSURE

With the development and popularization of computer and Internet technology, the conventional marketing mode is gradually being changed into the web marketing mode, so the web marketing and web advertising are more and more popular and accepted by the public. Whereas, how to analyze and evaluate the access traffic and the access effect of websites and web advertising published on the websites objectively and effectively is a technical problem to be solved now. By the earliest method for analyzing the web advertising effect, only the numbers of display and click are measured; however, with the development of technology, advertisers focus more on the transmission data of orders, etc., and try to figure out and transform the complex causal relationship between contact (referring to the actions of reaching websites of advertisers via various channels or methods of Internet users and the corresponding information about the actions) and web advertising. The measurement of web advertising effect is being changed from “extensive form” to “fine form”.

In the current technologies for measuring effect, the common processing method is to completely attribute the transformation of online orders, etc., to the web access during the transformation or to the web access from the first-time promotion. Such traditional attribution method is in fact a one-sided measurement way, and characterized in “single-contact” attribution, namely, one access and the corresponding channel are the whole reason for transformation. Most current website analysis tools use the above-mentioned single-contact attribution method by default. Apparently, the mature technology for analyzing and evaluating web advertising should take the contribution from various channels during the behavioral cycle of a user from FirstClick to LastClick into account comprehensively and must trace and emphasize the source and bridge of transformation. However, no such technical documents are available currently.

### SUMMARY OF THE DISCLOSURE

In view of the defects in the prior art, the objective of the disclosure is to provide a method and a system for measuring a web advertising effect based on a multiple-contact attribution model to fully understand and analyze the actual web advertising effect from a number of perspectives.

For the above purpose, the technical solution adopted by the disclosure is a method for measuring the web advertising effect based on the multiple-contact attribution model, including the following steps that:

user access information and purchase transformation information of a website to be monitored are collected and are uploaded to a server side; data is cleaned for the access information and the purchase transformation information on the server side to obtain contact data and transformation data; contact contribution value data is calculated by using the attribution model based on the contact data and the transformation data; and the contribution value data is imported into an On-Line Analytical Processing (OLAP) database, and a multi-dimensional data warehouse is created for inquiry.

The disclosure further provides a system for measuring a web advertising effect based on a multiple-contact attribution model, including:

an information collecting unit, which is configured to collect user access information and purchase transformation information of a website to be monitored, and upload the information to a server side;

a data cleaning unit, which is configured to clean, extract and transform data for the access information and the purchase transformation information on the server side to obtain contact data and transformation data;
a contribution value acquisition unit, which is configured to calculate contact contribution value data by using the attribution model based on the contact data and the transformation data; and
a database warehouse creating unit, which is configured to import the contribution value into an OLAP database, and create a multi-dimensional data warehouse by aggregating data by the OLAP.

The disclosure replaces the conventional single-contact one-sided attribution method with a multi-perspective multi-contact attribution calculation method. Based on this, it is possible to help advertisers objectively and fully understand and evaluate the web advertising effect to accurately measure underestimated or overestimated channel value in the conventional methods, thereby providing the most accurate data support for optimizing web advertising and improving rate of return on investment.

### BRIEF DESCRIPTION OF THE DRAWINGS

FIG. 1 is a flowchart showing a method for measuring a web advertising effect based on a multiple-contact attribution model provided by one embodiment of the disclosure;

FIG. 2 is a diagram showing an interface for presenting a multi-dimensional analysis result in one embodiment of the disclosure; and

FIG. 3 is a diagram showing the structure of a system for measuring a web advertising effect based on a multiple-contact attribution model provided by one embodiment of the disclosure.

### DETAILED DESCRIPTION OF THE EMBODIMENTS

The disclosure is further described below with reference to the accompanying drawings and embodiments.

The multi-perspective multi-contact attribution calculation method adopted by the embodiment of the disclosure can help advertisers objectively and fully understand and evaluate the web advertising effect to accurately measure underestimated or overestimated channel value in the conventional methods, thereby providing the most accurate data support for optimizing web advertising and improving rate of return on investment.

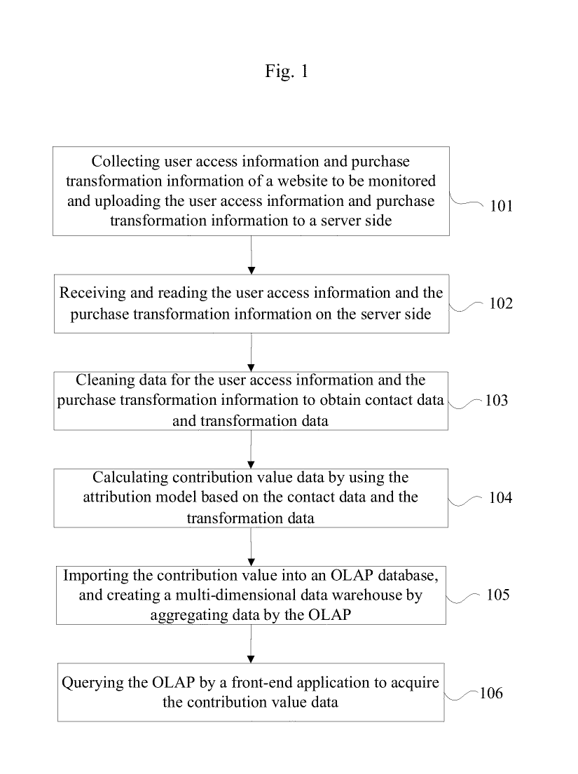

As shown in FIG. 1, a method for measuring a web advertising effect based on a multiple-contact attribution model includes the following steps that:

Step 101: User access information and purchase transformation information of a website to be monitored are collected and are uploaded to a server side; and a javascript code is added in the background of the website to be monitored, and runs each time a user accesses the website to collect the access information and the purchase transformation information of the user and send the access information and the purchase transformation information to a server side.

Step 102: The access information and the purchase transformation information are received and read on the server side, and are imported to a file for the access information and the purchase transformation information and stored into a database.

Step 103: Data is cleaned for the access information and the purchase transformation information to obtain contact data and transformation data, wherein the data cleaning includes integration and deduplication of multi-source data and cleaning of dirty data.

Step 104: Contribution value data is calculated by using the attribution model based on the contact data and the transformation data.

The so-called attribution model refers actually to a method and a policy for calculating the contribution value data by the transformation data and the contact data. The specific definition and algorithm of the attribution model are given below:

During the calculation of the contribution value, only the ordered contact set E and its transformation set C of a single user are taken into consideration due to relative independence of serial behaviour from different users.

E={e₁, e₂, . . . , eₙ}

C={c₁, c₂, . . . , cₘ}

Where n represents the total of contacts of the user, and m represents the total of transformation.

A bind function is defined to express which contact the transformation is after:

bind: {1, 2, . . . , m}→{1, 2, . . . , n}

Therefore, the calculation of the attribution model only needs to determine a corresponding function substantially, which is called contribution allocation function. The contribution allocation function is used for determining the contribution weight values of relevant contacts. As for a specific transformation cⱼ, the function is defined as:

fᵢ:[e₁,e_{bind(j)}]→[0,1]

and should stratify:

$${\sum }_{i = 1}^{bind ( j )} {f}_{j} ( {e}_{i} ) = 1$$

Finally, after the contribution allocation function corresponding to the attribution model is determined, the contribution value of contact eᵢ can be calculated:

$$AV ( {e}_{i} ) = {\sum }_{j = 1}^{m} {f}_{j} ( {e}_{i} ) V ( {c}_{j} )$$

Where V(cⱼ) represents the original value transformed cⱼ, such as an order amount. It is apparent from the expression that the attribution process is in fact a reallocation for the transformation, and the total of allocated contribution values is equal to that of original transformation values. In rare cases, some special attribution models may show the characteristic of Σᵢ₌₁^{bind(j)}fⱼ(eᵢ)≠1 to meet some special requirements. Accordingly, it will result in the function of increasing or decreasing the total contribution value. Since such models are not typical and their calculation ideas and methods are the same as the normal models, no further explanation is made here.

The contribution allocation functions of several simple attribution models are as follows:

$$FirstClick model \text{:} {f}_{j} ( {e}_{i} ) = \{ \begin{matrix}1 & ( i = 1 ) \\ 0 & ( i \neq 1 )\end{matrix} \\ AvgClick model \text{:} {f}_{j} ( {e}_{i} ) = \frac{1}{bind ( j )} \\ LastClick model \text{:} {f}_{j} ( {e}_{i} ) = \{ \begin{matrix}1 & ( i = bind ( j ) ) \\ 0 & ( i \neq bind ( j ) )\end{matrix} \\ FirstLastClick model \text{:} \\ If bind ( j ) = 1 , \\ {f}_{j} ( {e}_{i} ) = \{ \begin{matrix}0.5 & ( i = 1 ) \\ 0.5 & ( i = bind ( j ) ) \\ 0 & ( i \neq bind ( j ) and i \neq 1 )\end{matrix} \\ If bind ( j ) \neq 1 , {f}_{j} ( {e}_{i} ) = 1.$$

On the basis of the simple attribution models above, a smart attribution model can be introduced. Its core idea is to drop the weight of some meaningless contacts, thereby increasing the accuracy of measuring the advertising effect. The following method can be used for defining its contribution allocation function:

A new virtual ordered contact set is introduced based on the original contact set E, and a single element in the set represents one or more physical contacts:

\tilde{E}={\tilde{e}₁,\tilde{e}₂, . . . ,\tilde{e}\tilde{eₚ}}

Normally, the physical contact, which is judged as a duplicated one or an interfered one, may form a virtual contact together with the latest non-weight-dropped contact, so as to join the first-time contribution allocation as a unit. The specific determination and combination methods can take advantage of session ID, occurrence time, etc., or be adjusted according to the actual occasions.

This embodiment uses two mappings to represent the relationship between sets E and \tilde{E}:

v: {1, . . . ,n}→{1, . . . ,p}

v⁻¹: {\tilde{e₁}, . . . ,\tilde{eₚ}}→{{eₐ_{₀}₊₁, . . . ,eₐ_{₁}}, . . . ,{eₐ_{ₚ₋₁}₊₁, . . . ,eₐ_{ₚ}}}

Where sequence aᵢ satisfies:

$$\{ \begin{matrix}{a}_{0} = 0 \\ {a}_{i} + 1 \leq {a}_{i + 1} \\ {a}_{p} = p\end{matrix}$$

Then, two child contribution allocation functions are defined as follows:

\tilde{f}ⱼL{\tilde{e₁}, . . . ,\tilde{e}_{v(bind(j))}}→[0,1] satisfies Σₖ₌₁^{v(bind(j))}\tilde{f}ⱼ(\tilde{eₖ})=1

{tilde over (\tilde{f}ⱼ: v⁻¹(\tilde{e}_{v(bind(j))})→[0,1] satisfies Σ_{k∈v}_{^{−1}}_{(\tilde{e}}_{_{v(bind(j)))}}{tilde over (\tilde{f}ⱼ(eₖ)=1

By doing so, the contribution allocation function can be represented as the product of two child contribution allocation functions, that is, two contribution allocations:

fⱼ(eᵢ)=\tilde{f}ⱼ(\tilde{e}ᵥ₍ᵢ₎){tilde over (\tilde{f}ⱼ(eᵢ)

The child contribution function can be realized by referring to the simple models above, such as FirstClick or AvgClick used in the child range, or adjusted flexibly according to the specific needs.

The smart attribution model based on the virtual contact has the following advantages:

1. Anti-concentration. For the duplicated contacts in a period of time (those passing through the same channel in a short interval), the embodiment will drop the weight.

2. Anti-interference. A contact from this site or an unknown site and a contact returned from a third-party website partner, such as Alipay, to this site, are filtered or dropped in weight.

3. Anti-direct-skip. The direct-skip refers to a channel which is easy to act and facilitate the final transformed character in the common environment of the internet, such as directly accessing or navigating a brand word in Baidu. And these contacts can also be filtered or dropped in weight.

4. Multi-metrics. In the conventional attribution models, the metric is single. However, this embodiment uses order number, order amount, merchandise number, merchandise amount and other metrics to help advertisers judge the investment return more accurately and advertise better. And there are association and derivation among the metrics, so the insight effect is better.

5. Parameterization. The parameterization refers to the allocation algorithm of weight, model formula and parameter variability, and after the parameters are adjusted, the history data can be modified again to make the data more accurate.

The following example particularly explains the process of calculating the contribution value according to the attribution model. Provided that a user accesses a website 5 times from different channels, and the transformation is made in the last time and an order of 300 Yuan is created. The information of 5 contacts is as follows:

| | | | Transformation |
|---|---|---|---|
| Time of Access | Source Channel | Session ID | Value (Yuan) |
| 1 | Search engine | 1 | 0 |
| 2 | Portal | 2 | 0 |
| 3 | Search engine | 3 | 0 |
| 4 | Direct access | 3 | 0 |
| 5 | Payment website | 3 | 300 |

According to principles of anti-duplication and anti-interference (here, the direct access and payment website in the same session are merged forwards), it is easy to obtain a virtual contact set and use the AvgClick model:

| | | | Contribution |
|---|---|---|---|
| Time of Virtual Access | Source Channel | Session ID | Value (Yuan) |
| 1 | Search engine | 1 | 100 |
| 2 | Portal | 2 | 100 |
| 3 | Search engine, | 3 | 100 |
| | direct access, | | |
| | payment website | | |

In the subsequent second contribution allocation, the FirstClick model is used to obtain the final contribution value data:

| | | | Contribution |
|---|---|---|---|
| Time of Access | Source Channel | Session ID | Value (Yuan) |
| 1 | Search engine | 1 | 100 |
| 2 | Portal | 2 | 100 |
| 3 | Search engine | 3 | 100 |
| 4 | Direct access | 3 | 0 |
| 5 | Payment website | 3 | 0 |

It can be seen that the attribution model is accurate and flexible and capable of facilitating the right understanding of source channel effect and contribution weight, which is remarkably advantageous compared with the conventional extensive single-contact attribution.

Step 105: The contribution value calculated in the last step is imported into an OLAP database, and a multi-dimensional data warehouse is created by aggregating data by the OLAP.

During designing the multi-dimensional data warehouse, the contribution values should be used as the main metric of data cube, while the design of dimension and dimension property should take various contact information facilitating business analysis into account, such as source channel, landing page advertising parameter and browser information. The specific Extract-Transform-Load (ETL, i.e., the process of data extraction, transformation, loading) and data cube processing methods are well-known in the art, so no further explanation is needed.

Step 106: The OLAP is queried by a front-end application to acquire the contribution value data. Since the OLAP provides the multi-dimensional analysis and inquiry capabilities, a client can set a filter conditions from multiple perspectives and acquire the grouping and aggregation result of the filtered contribution value. The aggregated contribution value data can be used as a quantitative metric for measuring advertising effect and a foundation for advertising decision.

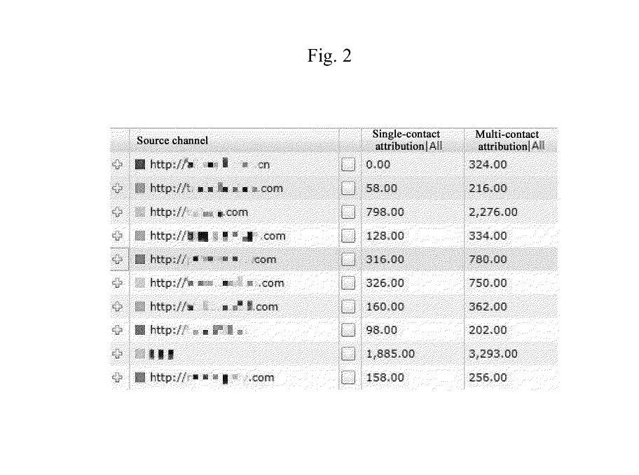

FIG. 2 shows an interface for presenting the result of the multi-dimensional analysis above. It can be seen that, as for the channels in the figure, the conventional single-contact attribution underestimates their actual values, while the multi-contact attribution restores their contributions more accurately.

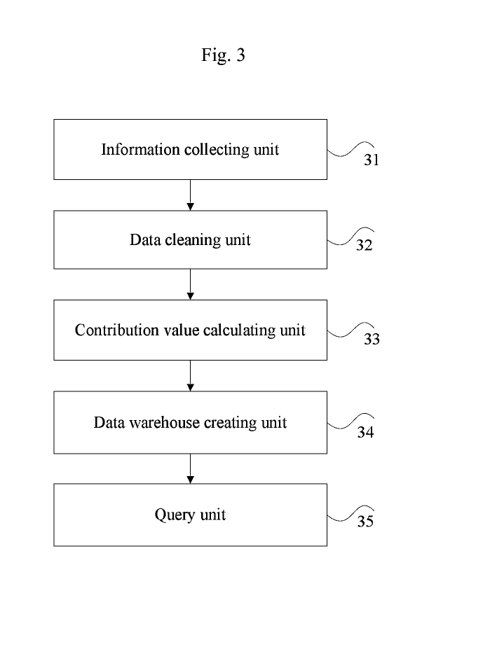

Referring to FIG. 3, FIG. 3 is a diagram showing the structure of a system for measuring a web advertising effect based on a multiple-contact attribution model provided by one embodiment of the disclosure, specifically including:

an information collecting unit 31, which is configured to collect user access information and the purchase transformation information of a website to be monitored, and upload the information to a server side;

a data cleaning unit 32, which is configured to clean data for the access information and the purchase transformation information on a server side to obtain contact data and transformation data;

a contribution value acquisition unit 33, which is configured to calculate contact contribution value data by using the attribution model based on the contact data and the transformation data;

a database warehouse creating unit 34, which is configured to import the contribution value into an OLAP database, and create a multi-dimensional data warehouse by aggregating data by the OLAP;

a query unit 35, which is configured to query the OLAP to acquire the contribution value data, and set a filter condition from multiple perspectives and acquire the grouping and aggregation result of the filtered contribution value to quantify the channel value.

To sum up, the multi-contact attribution model provided by this embodiment can fully measure and calculate the actual contributions of respective advertising channels, which is significant for the effect measurement of web advertising.

The method and the system of the disclosure are not limited to the embodiments of the specific implementation way, and other implementation ways made by those skilled in the art according to the technical solution of the disclosure also belong to the technical innovation scope of the disclosure.

1. A method for measuring a web advertising effect based on a multiple-contact attribution model, comprising:
collecting user access information and purchase transformation information of a website to be monitored, and uploading the information to a server side; cleaning data for the access information and the purchase transformation information on the server side to obtain contact data and transformation data; calculating contribution value data by using the attribution model based on the contact data and the transformation data;
and importing the contribution value into an On-line Analytical Processing (OLAP) database, and creating a multi-dimensional data warehouse for inquiry.

2. The method for measuring the web advertising effect based on the multiple-contact attribution model according to claim 1, wherein collecting the user access information and the purchase transformation information of the website to be monitored, and uploading the user access information and the purchase information to the server side specifically comprise:
adding a javascript code in the page of the website to be monitored, and running the javascript code when a user accesses the website to collect the user access information and the purchase transformation information of the user and send the access information and the purchase transformation information to the server side.

3. The method for measuring the web advertising effect based on the multiple-contact attribution model according to claim 1, wherein cleaning the data comprises integration and deduplication of multi-source data and cleaning of dirty data.

4. The method for measuring the web advertising effect based on the multiple-contact attribution model according to claim 1, wherein calculating the contribution value data by using the attribution model specifically comprises:
when calculating the contribution value, using the ordered contact set E and its transformation set C of a single user:
E={e₁, e₂, . . . ,eₙ}, C={c₁,c₂, . . . ,cₘ}
where n represents the total of contacts of the user, and m represents the total of transformation;
defining a bind function to express which contact the transformation is after:
bind: {1,2, . . . ,m}→{1,2, . . . ,n}
determining a contribution allocation function, and as for a specific transformation cⱼ, defining the function as:
fⱼ: [e₁,e_{bind(j)}]→[0,1]
satisfying:
$${\sum }_{i = 1}^{bind ( j )} {f}_{j} ( {e}_{i} ) = 1$$
after the corresponding contribution allocation function of the attribution model is determined, calculating the contribution value of contact eᵢ:
$$AV ( {e}_{i} ) = {\sum }_{j = 1}^{m} {f}_{j} ( {e}_{i} ) V ( {c}_{j} )$$
where V(cⱼ) represents the original value transforming cⱼ.

5. The method for measuring the web advertising effect based on the multiple-contact attribution model according to claim 4, wherein the contribution allocation function of the simple attribution model obtained based on the attribution model comprises:
$$FirstClick model \text{:} {f}_{j} ( {e}_{i} ) = \{ \begin{matrix}1 & ( i = 1 ) \\ 0 & ( i \neq 1 )\end{matrix} \\ AvgClick model \text{:} {f}_{j} ( {e}_{i} ) = \frac{1}{bind ( j )} \\ LastClick model \text{:} {f}_{j} ( {e}_{i} ) = \{ \begin{matrix}1 & ( i = bind ( j ) ) \\ 0 & ( i \neq bind ( j ) )\end{matrix} \\ FirstLastClick model \text{:} \\ If bind ( j ) = 1 , {f}_{j} ( {e}_{i} ) = \{ \begin{matrix}0.5 & ( i = 1 ) \\ 0.5 & ( i = bind ( j ) ) \\ 0 & ( i \neq bind ( j ) and i \neq 1 )\end{matrix} \\ If bind ( j ) \neq 1 , {f}_{j} ( {e}_{i} ) = 1.$$

6. The method for measuring the web advertising effect based on the multiple-contact attribution model according to claim 4, wherein the contribution allocation function of the smart attribution model obtained based on the attribution model comprises:
A new virtual ordered contact set introduced based on the original contact set E, a single element in the new virtual ordered contact set representing one or more physical contacts:
\tilde{E}={\tilde{e}\tilde{e₁},\tilde{e}\tilde{e₂}, . . . ,\tilde{e}\tilde{eₚ}}
two mappings representing the relationship between sets E and \tilde{E}:
v: {1, . . . ,n}→{1, . . . ,p}
v⁻¹: {\tilde{e₁}, . . . ,\tilde{eₚ}}→{{eₐ_{₀}₊₁, . . . ,eₐ_{₁}}, . . . ,{eₐ_{ₚ₋₁}₊₁, . . . ,eₐ_{ₚ}}}
where sequence aᵢ satisfies:
$$\{ \begin{matrix}{a}_{0} = 0 \\ {a}_{i} + 1 \leq {a}_{i + 1} \\ {a}_{p} = p\end{matrix}$$
two child contribution allocation functions are defined as follows:
\tilde{f}ⱼ: {\tilde{e}\tilde{e₁}, . . . , \tilde{e}_{v(bind(j))}}→[0,1] satisfies Σₖ₌₁^{v(bind(j))\tilde{f}}ⱼ(\tilde{e}\tilde{eₖ})=1
{tilde over (\tilde{f}ⱼ: v⁻¹(\tilde{e}_{v(bind(j)))→[}0,1] satisfies Σ_{k∈v}_{^{−1}}_{(\tilde{e}}_{_{v(bind(j))}}){tilde over (\tilde{f}ⱼ(eₖ)=1
the contribution allocation function is represented as the product of the two child contribution allocation functions:
fⱼ(eᵢ)=\tilde{f}ⱼ(\tilde{e}ᵥ₍ᵢ₎){tilde over (\tilde{f}ⱼ(eᵢ).

7. The method for measuring the web advertising effect based on the multiple-contact attribution model according to claim 1, wherein when the multi-dimensional data warehouse is created, the contribution value calculated by using the multi-contact attribution model is used as the basic metric of the multi-dimensional data warehouse and the related contact information of the contribution value is used as dimension and dimension property.

8. The method for measuring the web advertising effect based on the multiple-contact attribution model according to claim 1, wherein after the multi-dimensional data warehouse is created, by a front-end application, querying the OLAP database to acquire the contribution value data and setting a filter condition from multiple perspectives to acquire the grouping and aggregation result of the filtered contribution value and quantify the channel value.

9. A system for measuring a web advertising effect based on a multiple-contact attribution model, comprising:
an information collecting unit, which is configured to collect user access information and purchase transformation information of a website to be monitored, and upload the user access information and purchase transformation information to a server side;
a data cleaning unit, which is configured to clean, extract and transform data for the user access information and the purchase transformation information on a server side to obtain contact data and transformation data;
a contribution value acquisition unit, which is configured to calculate contribution value data by using the attribution model based on the contact data and the transformation data; and
a database warehouse creating unit, which is configured to import the contribution value into an OLAP database, and create a multi-dimensional data warehouse by aggregating data by the OLAP.

10. The system for measuring the web advertising effect based on the multiple-contact attribution model according to claim 9, the system further comprising:
a query unit, which is configured to query the OLAP to acquire the contribution value data, and set a filter condition from multiple perspectives and acquire the grouping and aggregation result of the filtered contribution value.

11. The method for measuring the web advertising effect based on the multiple-contact attribution model according to claim 2, wherein cleaning the data comprises integration and deduplication of multi-source data and cleaning of dirty data.
